(19) United States
(12) Patent Application Publication
(10) Pub. No.: US 2001/0018298 A1
(43) Pub. Date: Aug. 30, 2001

(54) Polygonal coil spring contactor, and connector and capacitor using the contactor

(76) Inventors: Takaya Nakamura, Saitama-Ken (JP); Asao Ishikawa, Abiko-Shi (JP); Michiharu Takahashi, Yachiyo-Shi (JP)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/793,764

(22) Filed: Feb. 27, 2001

(30) Foreign Application Priority Data
Feb. 28, 2000 (JP) 2000-51168

(51) Int. Cl. H01R 13/33

(52) U.S. Cl. 439/841

(57) ABSTRACT

An electrical contactor has low electrical contact resistance and superior durability. Disclosed are (1) a coil spring contactor comprising a coil conductor, comprising an elastic conductive wire material wound into a tubular coil having a substantially polygonal horizontal cross-sectional shape, a conductive effect being created when another conductive member directly contacts at least one of the inner and outer faces of the tubular coil; and a sleeve which contains the coil conductor and holds it along the axis line of the tubular coil; (2) a coil spring contactor comprising a coil conductor, comprising an elastic conductive wire material wound into a tubular coil which is elliptical in horizontal cross-section, a conductive effect being created when another conductive member directly contacts at least one of the inner and outer faces of the tubular coil; and a sleeve which contains the coil conductor and holds it along the axis line of the tubular coil; (3) a connector, an elbow connector, a multi-terminal connector, and a capacitor using these coil spring contactors.

### BACKGROUND OF THE INVENTION

1. Field of the Invention

The present invention relates to an electrical contactor used in a connector for electrical devices, and more particularly relates to improvements in the conductive characteristics of the contactor.

2. Description of the Related Art

Connectors are widely used in connecting electrical devices, electronic devices, electronic appliances, electric wires, and the like. Generally, a connector comprises a pin-shaped male contactor and a female contactor which deforms when the male contactor is inserted therein, as seen for example in coaxial connectors, pin connectors, plug-jack connectors for earphones and the like.

FIG. 11 shows the structure of a connector which is used when connecting electric wires together. A male contactor 100 has a rounded tip. A female contactor 200 is cylindrical and has a slit so that, when the male contactor 100 is inserted, the female contactor 200 elastically deforms and pressingly touches the male contactor 100. FIG. 12 shows the internal structure of a coaxial connector which is termed an F-connector. An insulator 203 is inserted between an inside conductor 202 and a casing 201, which functions as an outside conductor. A male connector (not shown) is inserted into an insertion hole 204 from the right side of the diagram and connects to the internal conductor 202. The male connector is connected to the outside conductor 201 by screwing. FIG. 13 shows an example of the constitution of the contacting portion in another type of connector, wherein the inner side of a drum-like elastic conductor directly contacts the outside of the connected piece.

FIG. 14 shows the internal constitution of a coaxial connector having a simple shape. The internal conductor of the coaxial connector contacts the V-shaped opening of a spring conductor 202a (on the far right side of the diagram).

FIG. 15 shows an elbow connector in which two conductors 202 are provided at right angles to each other and are connected together by a joining element 300. This structure requires complex mechanical processes.

Lastly, FIG. 16 shows a multi-terminal connector used in IC connection, comprising a plurality of terminals on a circuit board PCB. At each terminal, an IC lead 100aelastically contacts a board-spring contactor 200a which is contained in a metal sleeve 200b.

As described above, conventional connectors obtain a conductive effect from the pressing contact between the inner and outer faces of a male conductor and a female conductor. Therefore, although the male conductor and the female conductor deform, they are connected merely by contact between their faces at several connecting points.

This type of connection inevitably has a certain degree of electrical contact resistance. Needless to say, this results in attenuated signals, and a considerable amount of heat is generated at the connection when a signal is transmitted in multiplex with electrical power. Heat generation causes metal fatigue and warping, consequently damaging the connection.

Further, diode effect in a connection based on points of contact can cause distortion of transmitted signals. The surface of the conducting metal is easily oxidized, and for this reason an oxidizing layer is provided thereon. When part of the oxidizing layer acts as a conductive contact, a diode effect becomes unavoidable.

An additional problem is that the conventional connector has a structure which is repeatedly connected and disconnected, with deforming and reforming being concentrated at specific portions. This repetition leads to fatigue and adversely affects the conductive characteristics. Concentrated deforming is also caused by positional deviation when mounting the connector, and by the fact that restrictions on the size of the connector result in less than optimum conditions.

Types of connectors which use such a contacting structure are liable to become defective.

### SUMMARY OF THE INVENTION

The present invention has been achieved in order to solve the above problems. It is an object of this invention to provide an electrical contactor which has low electrical contact resistance and excellent durability.

In order to achieve the above objects, this invention provides the following.

(1) A coil spring contactor comprising a coil conductor, comprising an elastic conductive wire material wound into a tubular coil having a substantially polygonal horizontal cross-sectional shape, a conductive effect being created when another conductive member directly contacts at least one of the inner and outer faces of the tubular coil; and a sleeve which contains the coil conductor and holds it along the axis line of the tubular coil.

(2) A coil spring contactor comprising a coil conductor, comprising an elastic conductive wire material wound into a tubular coil which is elliptical in horizontal cross-section, a conductive effect being created when another conductive member directly contacts at least one of the inner and outer faces of the tubular coil; and a sleeve which contains the coil conductor and holds it along the axis line of the tubular coil.

(3) A connector, an elbow connector, a multi-terminal connector, and a capacitor using the above coil spring contactors.

### BRIEF DESCRIPTION OF THE DRAWINGS

FIG. 1 is a perspective view of an example of the constitution of a coil spring contactor according to this invention;

FIG. 2A is a perspective view of the constitution of an embodiment of this invention, and FIG. 2B, an end view of the constitution of another embodiment;

FIG. 3 is a diagram showing an embodiment achieved by removing the male contactor from FIG. 1 and using a polygonal conductive wire;

FIG. 4 is a diagram showing another embodiment comprising a coaxial connector;

FIG. 5 is a diagram showing an embodiment which is connected by inserting male contactors from the top and bottom;

FIG. 6 is a diagram showing an embodiment comprising a flat male contactor in combination with a female contactor;

FIG. 7 is a diagram showing an embodiment comprising an elbow connector;

FIG. 8 is a diagram showing an embodiment comprising a feedthrough capacitor;

FIG. 9 is a diagram showing an embodiment comprising another feedthrough capacitor;

FIGS. 10A and 10B are diagrams showing an embodiment comprising a multi-terminal connector;

FIG. 11 is a diagram showing the connecting relationship between conventional male and female contactors;

FIG. 12 is a diagram showing a conventional coaxial F-connector;

FIG. 13 is a diagram showing a conventional drum contactor;

FIG. 14 is a diagram showing a conventional coaxial connector having a simple shape;

FIG. 15 is a diagram showing a conventional right-angled connector; and

FIG. 16 is a diagram showing a conventional multi-terminal connector.

### REQUIREMENTS FOR ELECTICAL CONNECTORS

General requirements for electrical connectors are:

1. The connector can be easily disconnected.

2. The connector has low electrical contact resistance.

3. The connector has low heat generation.

4. There is no adverse affect on electrical signals passing through the connector.

5. Durability is sufficient for the conditions in which the connector is to be used.

6. The connector is adaptable to changes in the size of contactors inserted thereto.

This invention proposes a contactor which adequately satisfies all of these requirements.

The contactor which satisfies these conditions can be applied in various types of connectors and capacitors. Preferred embodiments of these are described below.

### PREFERRED EMBODIMENTS

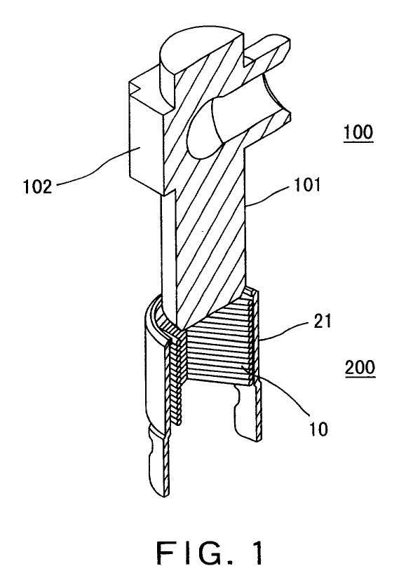

FIG. 1 is a vertical cross-sectional view of a one-terminal female contactor and a corresponding male contactor according to an embodiment of this invention. FIG. 1 shows the state in cross-section along the axis of this embodiment, the male contactor 100 being provided immediately above the embodiment which is represented by the reference numeral 200.

The embodiment 200 comprises a tubular coil 10 (hereinafter termed simply “coil 10”) which is formed by winding an elastic conductive wire material (hereinafter termed simply “conductor”) so that the horizontal cross-sectional shape thereof is pentagonal, and the coil 10 is provided inside a cylindrical sleeve 21. The top end (as viewed in the diagram) of the sleeve 21 is made narrow to restrict the position of one end of the coil 10. The bottom end (as viewed in the diagram) of the sleeve 21 restricts the position of the other end of the coil 10.

The position of the coil 10 is restricted insofar as it cannot move freely along the axis of the sleeve 21. The coil 10 has little freedom, since all its vertexes directly contact the inner wall of the sleeve 21 parallel to the diameter thereof, but the pentagonal portion is not restricted from deforming. As a result, the coil 10 is held with a certain degree of freedom within the sleeve 21.

When a rod-like section 101, which runs from a terminal section 102 of the male contactor 100, is inserted to the axis position of the coil 10, the outer face of the rod-like section 101 pressingly contacts the inner face of the coil, i.e. the succession of semi-cylindrical faces of the conductor which comprises the coil 10. Since the coil 10 is polygonal, it contacts the male contactor 100 at multiple points, enabling the male contactor 100 to be smoothly inserted into the coil 10. The same applies when removing the male contactor 100 from the coil 10.

Assuming that there are five contact points each time the conductor of the coil 10 is turned, the number of contact points will be five times the number of turns of the conductor. If the coil 10 were turned ten times, there would be fifty contact points. Since there are so many contact points between the male contactor 100 and the female contactor 200, and between the coil 10 and the sleeve 21, extremely good electrical contact is obtained between the male contactor 100 and the sleeve 21.

Therefore, very little heat is generated. According to test results obtained by passing dc current through the main line terminal in a splitter for CATV, when current of 25 V and 24 A was continuously injected over a long period of time, the temperature of a conventional contactor increased by 30° C. In contrast, the temperature increase in the contactor of this invention was less than 10° C.

This is due to the fact the coil 10 becomes wound around the outer face of the rod-like section 101 of the male contactor 100, thereby achieving excellent contact. This arrangement achieves another extremely important effect. The coil 10 expands and contracts at the coefficient of linear expansion of its constituent material, whereby the conductor of the coil 10 moves around the outer face of the rod-like section 101 and the two rub together. Consequently, fresh surfaces of the coil 10 and the rod-like section 101 are exposed frequently, so that the contact faces are always fresh.

This cannot be envisaged in a conventional constitution where the faces of the two contacting members contact each other. In order to increase expansion and contraction of the coil 10, including that caused by heat, the coil 10 may be provided in units which are divided for an appropriate number of turns.

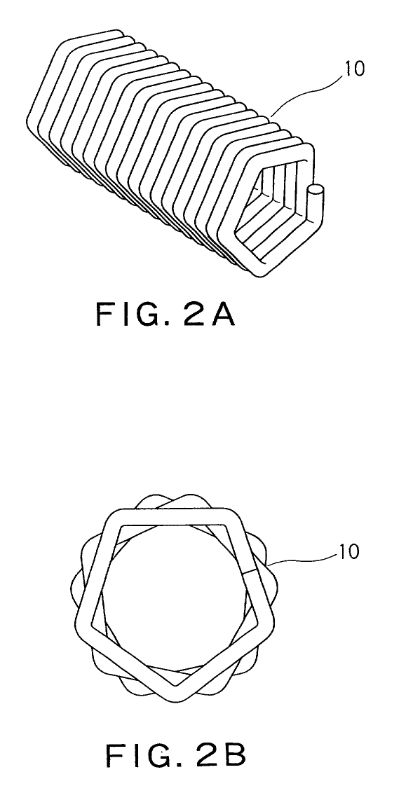

FIG. 2A is a perspective view of one example of the constitution of a coil spring contactor used in this invention. The contactor comprises a conductive wire which is circular in horizontal cross-section and is wound into a tube, thereby forming a coil 10. The horizontal cross-sectional shape of the coil 10 is a regular pentagon.

The horizontal cross-sectional shape of the coil 10 can be another polygon having more than three angles, or a shape similar to a polygon.

FIG. 2B is an end view of another example of the constitution of the coil spring contactor used in this invention.

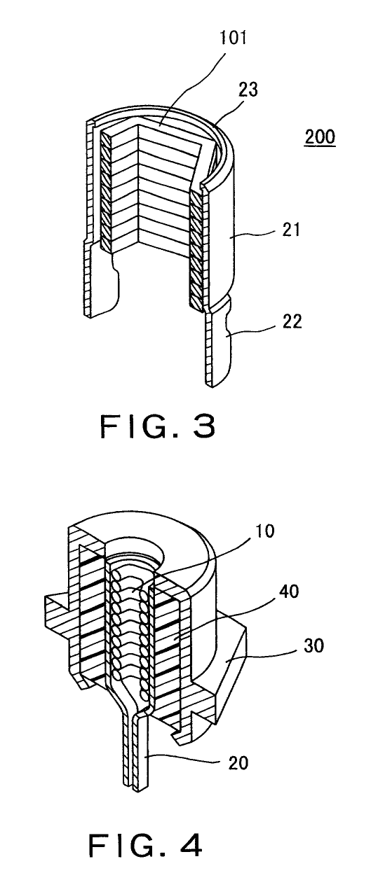

FIG. 3 shows the state when the male contactor 100 is removed from FIG. 1. Unlike FIG. 1, the coil 10 here comprises a conductor which is square in cross-section. For this reason, the inner face of the coil 10 forms a succession of flat faces instead of the succession of semi-cylindrical faces shown in FIG. 2.

The bottom end of the coil 10 (as shown in FIG. 3) is restrained by a coil-stopper (not shown) which is provided on the inner wall of the sleeve 21, and the top end of the coil 10 (as depicted in FIG. 3) is restrained by an edge 23 which is provided by forcibly indenting the top end of the sleeve 21.

Two stands 22 are provided at the bottom of the sleeve 21, and are used for securing and connecting the coil 10 to a circuit board or the like.

FIG. 4 is a vertical cross-sectional view of a coaxial two-terminal embodiment of this invention. In this embodiment, the coil 10 is provided in a sleeve 20, and this is placed inside a case 30 with an insulator 40 provided therebetween. The sleeve 20 functions as one terminal, the case 30 as another.

Excellent contact is achieved in this embodiment since the coil 10 contacts multiple points on the outer face of the male contactor (not shown).

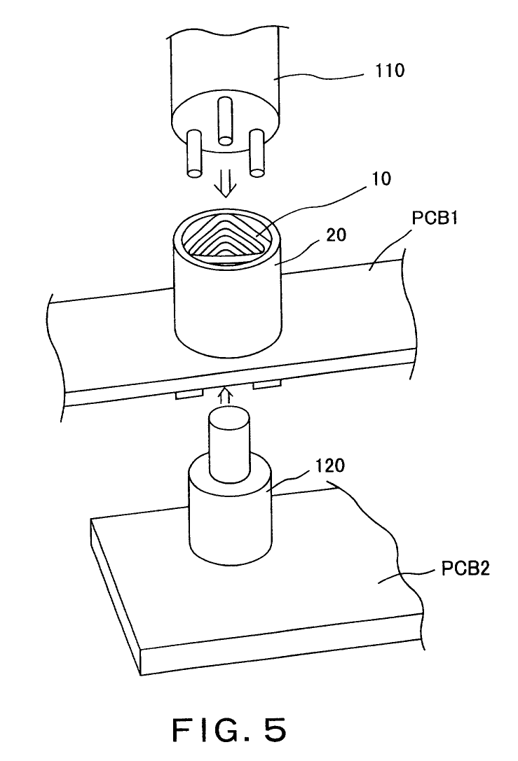

FIG. 5 shows another embodiment which can be connected to two male contactors. In this case, the coil 10 is wound so that its horizontal cross-sectional shape is triangular or square, thereby creating spaces which rod-like section of male contactors can be inserted into, not only inside the coil but also between the coil 10 and the sleeve 20. As shown in FIG. 5, a male contactor 120 is provided on a circuit board PCB2 at the bottom of the diagram and is inserted into the coil 10, which is attached to a circuit board PCB1, and contacts the coil 10. A male contactor 110 at the top of the diagram is inserted around the coil 10 and contacts it. Consequently, this embodiment can function as a collective connector for simultaneously connecting three elements.

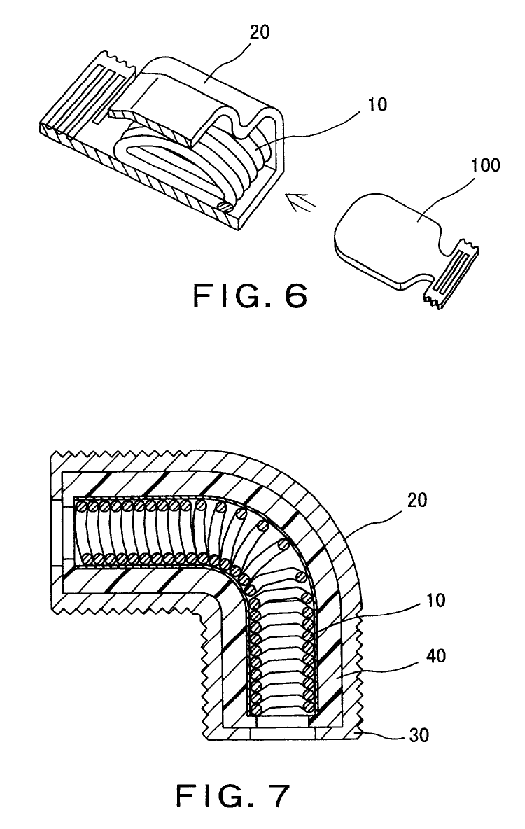

FIG. 6 shows an embodiment for connecting electric wires which combines male contactors having flat contact faces. In this embodiment, in order to smoothly insert the male contactor 100 having a flat contact face, the coil 10 is wound so that its horizontal cross-sectional shape is oval or oblong. The male contactor 100 is inserted parallel to the long diameter of the oval/oblong, sliding parallel to the length of the conductor of the coil 10. The direction which the conductor of the coil 10 extends in is slightly diagonal to the direction which the male contactor 100 is inserted in. This may be further accentuated by increasing the diagonal.

A case 20 is provided so as to create a space for inserting a male contactor 100 around the coil 10, and one end of the coil 10 in its long diameter direction is projected from an opening in the case 20.

To connect to an electric wire, a crimp terminal for wire connection is provided at the unopen end of the case 20. An identical crimp terminal is also provided on the base of the male contactor 100.

FIG. 7 shows an embodiment comprising an elbow connector. In this embodiment, an insulator 40 has a plated conductive layer on its inner face and is provided around the coil 10. This structure is provided inside a case 30, and the complete embodiment forms a cylindrical body. The cylindrical body functions as a coaxial conductor for connecting a pair of connection terminals which are arranged so as to form a predetermined angle therebetween (a right angle in FIG. 7).

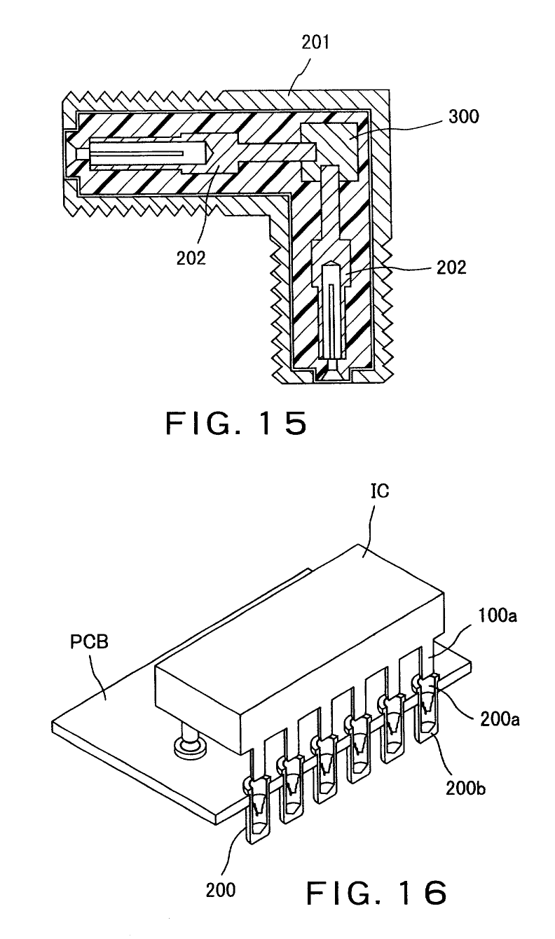

In this embodiment, a conventional joining element such as that shown in FIG. 15 is not needed, it being sufficient merely to bend the elements comprising the coil 10 by ninety degrees. Even when the angle is not a right angle, no other elements are required, since it is sufficient merely to change the angle of the bend.

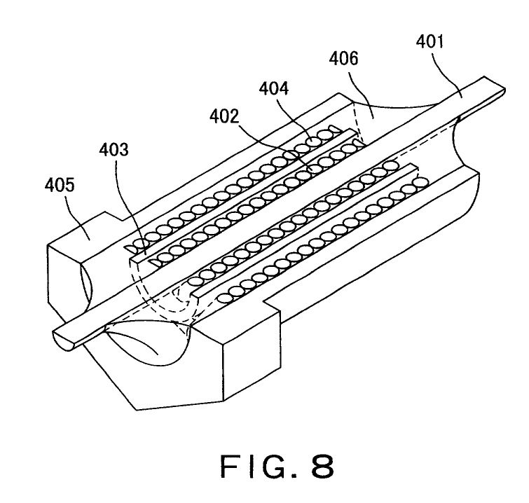

FIG. 8 shows an example in which this invention is applied in a feedthrough capacitor. An inside coil 402, a ceramic tubular dielectric 403 having conductive plating on its inner and outer faces, and an outside coil 404 which is connected to a ground terminal are provided coaxially around a core conductor 401 which is inserted as a terminal. A conductive shell is provided around the outer layer of this structure and secured by a layer of epoxy resin 406.

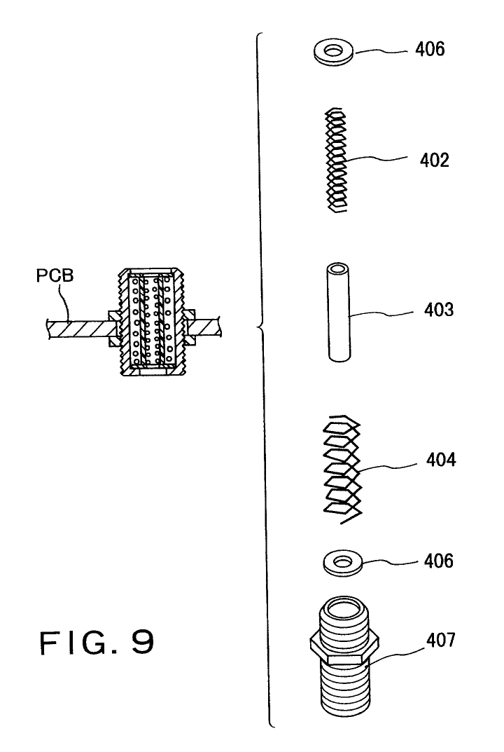

FIG. 9 shows an example in which this invention is applied in another feedthrough capacitor. The constitution of the capacitor of this invention, including that of the embodiment shown in FIG. 8, will be explained based on FIG. 9.

The inside coil 402, the tubular dielectric 403, and the outside coil 404 are inserted into a cylindrical space inside a conductive shell 407, and securing rings 406 are provided so as to cover the openings at the top and bottom ends.

The tubular dielectric 403 may, for example, comprise a ceramic cylinder having silver electrodes provided in its inner and outer faces. A nut attachment is provided in the conductive shell 407 and enables it to be secured to a circuit board PCB.

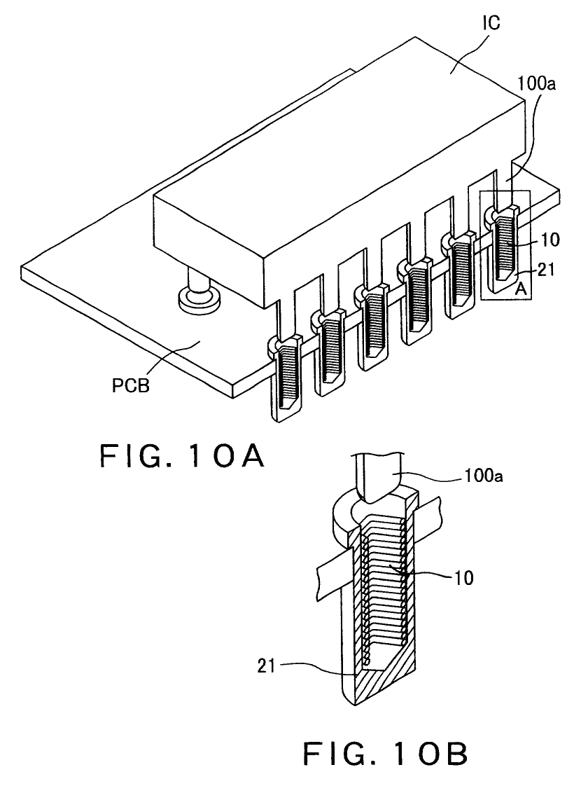

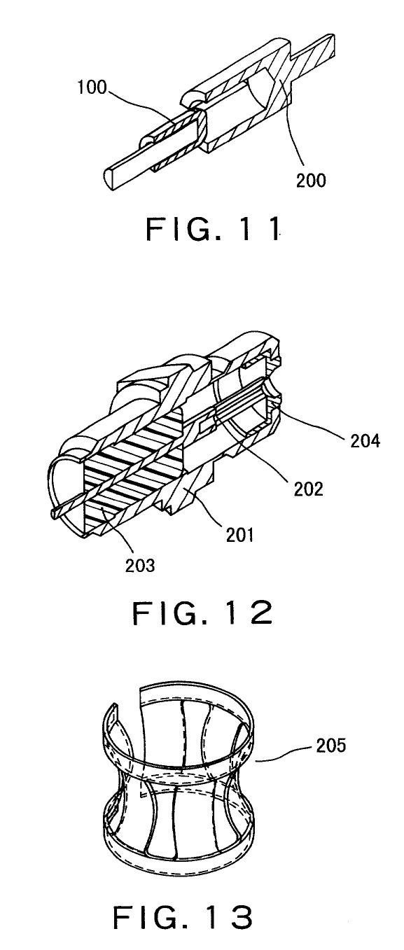

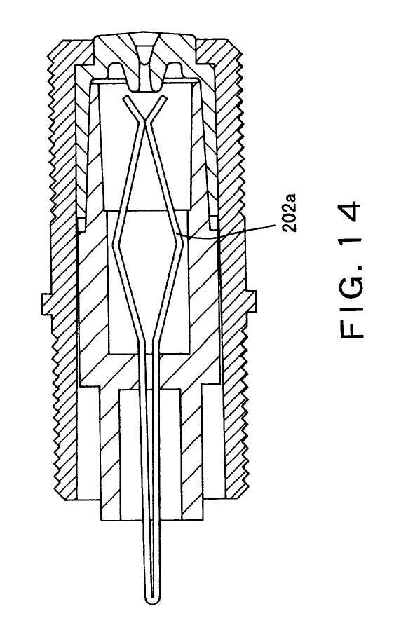

FIGS. 10A and 10B show the constitution of a multi-terminal connector which comprises an appropriate number of contactors selected from the above embodiments and arranged in a row to provide a socket for an IC and the like. FIG. 10A is a perspective view of the entire structure, and FIG. 10B is an enlarged view of the section represented in FIG. 10A by reference code A, i.e. one pin.

In a device such as an IC which handles extremely weak signal current, the quality of the connector more or less determines the capability of the IC. An excellent connector can be realized by using the contactor constitution of this invention.

Modifications

The above embodiments described coils having horizontal cross-sectional shapes which are regular polygons, a triangle with a rounded tip, and an oval, but other polygonal shapes, such as a ellipse, are acceptable. The conductor of the tubular coil need only be wound so as to create a plurality of contact points with the other contactor.

Beryllium copper and phosphorus bronze have elasticity, and may be used as the conductor of the coil 10. Alternatively, it is acceptable to use oxygen-free copper, tough pitch copper and the like, which have low electrical resistance.

The horizontal cross-sectional shape of the male contactor which is inserted into the coil may be circular or a shape suitable to the horizontal cross-sectional shape of the coil. Further, the direction of the insertion of the male contactor can be restricted by making the coil a shape which is not a regular polygon.

As described above, this invention comprises an elastic conductive wire material which is wound into a coil and provided in a sleeve, connection being achieved when other contactors pressingly contact the inner and outer faces of the coil. Therefore, there are a great many contact points with the other contactors, making it possible to achieve excellent contact. Moreover, when the coil which forms the contact face expands and contracts as a result of a temperature rise or the insertion and removal of a contact piece, it rubs against the other contactors and forms newly exposed faces. Therefore, the contact faces can be kept constantly fresh, preventing deterioration over time.

What is claimed is:

1. A coil spring contactor comprising:
a coil conductor, comprising an elastic conductive wire material wound into a tubular coil having a substantially polygonal horizontal cross-sectional shape, a conductive effect being created when another conductive member directly contacts at least one of the inner and outer faces of said tubular coil; and
a sleeve which contains said coil conductor and holds it along the axis line of said tubular coil.

2. The coil spring contactor as described in claim 1, said tubular coil being wound so that vertexes of said polygon are displaced in relation to each other.

3. A connector comprising:
a coil conductor, comprising an elastic conductive wire material wound into a tubular coil having a substantially polygonal horizontal cross-sectional shape; and
a sleeve which contains said coil conductor;
connection being achieved by inserting a conductor which pressingly contacts at least one of the inner and outer faces of said coil conductor.

4. The connector as described in claim 3, connection being achieved by a conductor which pressingly contacts the inner face of said coil conductor and a second conductor, which is different to said conductor and pressingly contacts the outer face of said coil conductor.

5. The connector as described in claim 4, said conductor and said second conductor being inserted to said coil conductor from different directions.

6. A connector comprising:
a coil conductor, comprising an elastic conductive wire material wound into a tubular coil having a substantially polygonal horizontal cross-sectional shape; and
a case which restricts the positions of both coil end faces of said coil conductor, and creates a space around part of the outer face of said substantial polygon;
connection being achieved by inserting a conductor into said space of said case approximately at a right angle to the axial direction of said tubular coil, the conductor pressingly contacting the outer face of said coil.

7. An elbow connector comprising:
a pair of connection terminals which are arranged in a predetermined angular relationship; and
a tubular body comprising a tubular coil as an inside conductor, a case as an outside conductor, and an insulator which is provided between said inside conductor and said outside conductor, the tubular body connecting said pair of connection terminals together.

8. A multi-terminal connector comprising a great number of terminals, each having a tubular coil buried therein, which are arranged in rows;
connection being achieved by inserting a rod-like pin into the inner face of each of said tubular coils, the rod-like pins pressingly contacting said inner faces.

9. A capacitor comprising:
a core conductor;
a first coil spring contactor which comprises a tubular coil and contacts the outside of said core conductor;
a dielectric sleeve which comprises a tube having electrode layers on its inner and outer faces and contacts the outside of said first coil spring contactor;
a second coil spring contactor which comprises a tubular coil and contacts the outside of said dielectric sleeve; and
a conductive shell which is provided around the outside of said second coil spring contactor.

10. The capacitor as described in claim 9, said tubular coil being wound so that its horizontal cross-sectional shape is polygonal.

11. The capacitor as described in claim 9, omitting at least one of said first coil spring contactor and said second coil spring contactor and relevant members thereof.

12. A capacitor comprising:
a tubular dielectric layer;
an inside conductor and an outside conductor, each comprising a tubular coil, which are provided coaxially on either side of said tubular dielectric layer; and
a conductive case which contains said inside conductor, said outside conductor, and said dielectric layer.

13. The capacitor as described in claim 12, said conductive case having a structure for attaching to an apparatus.
